(19) United States
(12) Patent Application Publication
(10) Pub. No.: US 2020/0224106 A1
(43) Pub. Date: Jul. 16, 2020

(54) SYSTEM FOR FILTERING LIQUIDS AND PARTICULATES FROM HYDROCARBONS

(71) Applicant: STEPHEN DUKE COOPER, FAIR OAKS RANCH, TX (US)

(72) Inventor: STEPHEN DUKE COOPER, FAIR OAKS RANCH, TX (US)

(21) Appl. No.: 16/837,679

(22) Filed: Apr. 1, 2020

Related U.S. Application Data
(63) Continuation of application No. 15/784,769, filed on Oct. 16, 2017.
(60) Provisional application No. 62/408,517, filed on Oct. 14, 2016.

(51) Int. Cl. C10G 33/06; B01D 17/04

(52) U.S. Cl. CPC C10G 33/06; B01D 17/042; B01D 17/044; B01D 17/045

(57) ABSTRACT

This is a system for filtering liquids and particulates from hydrocarbons. The system starts with an intake where hydrocarbons from a source are placed into an oil circuit within the hydrocarbon filtering apparatus. The hydrocarbon that is passed through the elements of the hydrocarbon filtering apparatus has liquid, such as water removed, as well as particulates. The process is an improvement on existing machines and that the apparatus is able to run at an decreased temperature and reduced pressure as compared to the current state of the art. An improved diffuser element is made using a central tube that has a multiplicity of apertures interspersed along the shaft of the tube. The central tube has an attachment end and a closed end opposite from the attachment end. The tube is wrapped with a metal mesh and the mesh clamped in place.

This application is based upon and claims priority from U.S. patent application Ser. No. 15/784,769, which is incorporated herein by reference.

### BACKGROUND OF THE INVENTION

### Field of the Invention

Applicant's invention relates to a device and system for filtering or separating contaminates from liquid hydrocarbons. More particularly, it relates to separating contaminate liquids such as water and contaminate particulates from fuels and lubricants, thus prolonging the useful life of the liquid hydrocarbon.

### Background Information

Liquid contaminants are a problem in hydrocarbons. Water droplets are emulsified in the hydrocarbon and consist mainly of microscopic particles suspended in the lubricant or fuel. The emulsified water is removed by reducing emulsification and increasing the size of the water droplets. Because of the emulsification, filtration requires a very specific process. Conventional separators use liquid coalescers (or a diffusers), or single stage liquid filter water separators, to remove water from hydrocarbons. Single stage filter separator are generally used when less efficient water and particulate removal is sufficient.

As used herein, “hydrocarbons” refers to various liquid forms of organic compounds that consist of hydrogen and carbon. Common hydrocarbons include, but are not limited to, petroleum based fuels, solvents, and lubricants.

Single stage coalescers generally take advantage of cartridges in which the cartridge is packed with a porous material. Filtration depends upon the difference in the density between the hydrocarbon and the contaminant. The diffuser cartridges mechanically filter solids and separate immiscible liquids. Commonly, water is removed from the hydrocarbon.

Water droplets that have been emulsified in hydrocarbons are exceptionally small—on the order of 30 microns or less. In a relatively clear oil, these emulsified droplets will not appear as drops at all, but rather they will make the oil appear cloudy.

The coalescer cartridge of the filter separator unit is designed to remove the solids and combine the particles of water into larger droplets. When the droplets are large enough, they will fall into a sump tank where the water accumulation can be removed.

A typical filter coalescer cartridge has a folder filter types of design. The contaminated hydrocarbon flows through a pleated assembly of fine-grade filter media. The folded or pleated design helps maximize the surface area of the filter in order to catch and hold the contaminating particulates. Solid contaminants are relatively easy to filter and can be almost completely removed from the hydrocarbons. However the water emulsion is not so easily removed. It passes through the coalescing media, graduating from a very fine grade material to a coarse grade material to effect the gradual coalescence of water particles from their original microscopic size to droplet size. The coalescer core provides rigidity to the cartridge.

Filter water separators can be either vertically mounted or horizontally mounted. A two stage filter separator provides a higher degree of water filtration. Two stage filters work by coalescing the fine droplets of water found in the emulsified state and separating these from the hydrocarbon. Flowing the contaminated hydrocarbon through the pores of the filter. Obstructions cause the emulsified droplets to be broken into minute particles of water and as these particles progress through the porous material, the droplets are coalesced into larger and larger sized droplets. As the droplets separate in the separator unit they are removed.

### SUMMARY OF THE INVENTION

The present invention is a system for filtering liquids and particulates from hydrocarbons. The system starts with an intake where hydrocarbons from a source are placed into an oil circuit within the hydrocarbon filtering apparatus (also known as a vacuum oil purifier). The hydrocarbon that is passed through the elements of the hydrocarbon filtering apparatus has liquid, such as water removed, as well as particulates. The process is an improvement on existing machines and that the apparatus is able to run at an decreased temperature and reduced pressure as compared to the current state of the art.

The present invention includes an improved diffuser element. The diffuser element is made using a central tube that has a multiplicity of apertures interspersed along the shaft of the tube. The central tube has an attachment end and a closed end opposite from the attachment end. The tube is wrapped with a metal mesh and the mesh clamped in place.

The intent of the apparatus is to keep machines running longer and with less downtime due to contaminants in the oil or hydrocarbons. Water can diffuse into oil or hydrocarbons. Left in the hydrocarbons, the water emulsion can actually break down the oil. Oil has a saturation curve with a specific gravity at 60° F. in the range of about 0.8-1.0. Water goes into a dissolved state in the hydrocarbon. Temperature can affect the state of the water in the hydrocarbons. If the hydrocarbon is a lubricant, the presence of dissolved water can cause increased wear of the machine that relies on the lubrication.

The improved diffuser element, because the apparatus is able to work using a lower temperature and decreased pressure, removes the same amount of water from the hydrocarbon as the existing state-of-the-art filters in about half the time using less energy.

The diffuser element takes the hydrocarbon/water mixture and runs it through a wrapped mesh element causing the water to form droplets and separate from the hydrocarbon. The vacuum and decreased temperature (as compared to existing filtering apparatuses) cause the liquid to go into a gaseous state and lift from the hydrocarbon. The problem is that if the water is put into a gaseous state to quickly, foam forms in the hydrocarbon. If the temperature is too high or the pressure to low then uncontrolled foam may result. This can cause the “boiling over” of the hydrocarbon/foam mixture which can enter into the vacuum pump of the apparatus disabling the apparatus.

Because the improved hydrocarbon filtering apparatus and diffuser element allow the hydrocarbon to be filtered at (or increased vacuum) reduced pressure than the current technology, filtering takes place at a lower temperature and at a more rapid rate without uncontrolled foaming. Under current technology, hydrocarbons are filtered at about 150° F. and 22″ Hg. It is desirable to refrain from heating the oil as much as possible because high temperature can adversely affect additives within the hydrocarbon.

While some old technology uses a cork like, porous material to filter the hydrocarbon, there is a large change of pressure so a lot of pressure is required to run the system. This means that is good with thin (less viscous) oils but not thicker (more viscous) ones. The improved diffuser element provides the best of all possibilities—the use of reduced temperature, increased vacuum, and the ability to process thicker oils.

The mesh that wraps the inner tube of the diffuser element provides surface area upon which the liquid can form bubbles from the emulsification. It is anticipated that the mesh wrap may have multiple sized holes. For example, there may be layers of mesh having smaller holes, then a layer of mesh with larger holes, and then more mesh with smaller holes. The larger hold the mesh can help separate the smaller hole mesh such that it acts as a barrier layer to keep the smaller holes from being obstructed by the mesh walls. The mesh can be made from a variety of substances, including but not limited to aluminum, stainless steel, other metals, plastic, and other materials.

As an example of one embodiment, without intended to be limiting, the diffuser element may be assembled by drilling ⅛″ diameter holes along the shaft of ¾″ pipe (or diffuser core tube). It is anticipated that the holes in the diffuser element may only be located along the length of the diffuser element in a single quarter strip. In other words, if a line is drawn along the length of the diffuser element, then the holes may be located in a 45° angle around the curve of the diffuser element to either side of the line. The diffuser element may be oriented in the extraction chamber such that holes generally point upwardly (relative to gravity or bottom of the filtering apparatus) and at 45° downward from there. The holes may be pointed generally upward in order that after the hydrocarbon is expelled from the tube or core, it enters into the layers of mesh in an upward direction but gravity tends to pull the hydrocarbon down through more of the mesh layer structure than if it simply entered and exited the mesh layers in one general direction. However, it is anticipated that the holes could be placed at any point around the length of the tube allowing hydrocarbon to exit the tube and enter the layers of mesh wrap from various orientations.

In order to help maintain the screen in place, spacer discs are attached near each end of the pipe at a distance slightly wider than the width of the screen so that the screen can be urged between the two (2) spacer discs. Approximately 20 feet of size 20 mesh screen will be wrapped around the pipe a multiplicity of times, preferably more than three (3) times around the tube. Typical mesh widths would be 20 inches wide or 30 inches wide. Those widths, there would be 33 ft.² of mesh per element for the 20 inch wide mesh, or 50 ft.² of mesh per element for the 30 inch wide mesh. An edge of the mesh screen is attached to the tube along the length of the tube between the spacer discs. The remaining mesh is tightly wrapped around the tube. In order to wrap the screen mesh, it is stretched out to its full length and then the pipe is rolled with resistance on the mesh in order to tightly wrap it. In order to help keep the holes open so that there is porosity throughout the diffuser element, spacer mesh may be installed. Spacer mesh is mesh that has larger holes than the mesh screen. In this embodiment, a short length of the spacer mesh is wrapped around the rod and screen mesh apparatus about every four (4) to six (6) rotations, or wraps, of the screen mesh. The spacer mesh is the same width as the screen mesh and is installed to keep the size 20 mesh wrap from binding into itself in impeding flow or causing a restriction in the flow of hydrocarbons through the diffuser element. The spacer mesh also helps the hydrocarbons flow over the entire depth of the size 20 mesh wrap, thus utilizing all the surface area of the size 20 mesh screen. In this embodiment, it is anticipated that the spacer mesh would be ⅛ inch mesh and 6 inch sections. Once the mesh screen has been wrapped around the pipe for the full length of the mesh screen, it is secured so that it does not unravel and so that the pipe/screen apparatus has a cylindrical shape. It can be secured using hose clamps, zip ties, or using many other connectors. It is important that the spacer discs are positioned close to the end of the mesh screen such that hydrocarbons do not bypass traveling through the mesh screen porous structure. In order to protect the structure, perforated tubing may be installed around the mesh structure. It can be welded or otherwise attached in place to secure and protect the mesh screen. The pipe is hollow and has an aperture at both ends. One of these apertures must be closed off and to do so a plug or cap is installed creating a closed end. The attachment end opposite the closed-end will be attached in the oil circuit of the hydrocarbon filtering apparatus. Hydrocarbons will enter into the interior of the pipe through the attachment and aperture and then because the opposite and is closed, the force through the holes in the shaft of the pipe and through the porous structure created by the wrapped mesh.

Another feature of the hydrocarbon filtering apparatus is the dual gasket viewing port used at multiple locations on the hydrocarbon filtering apparatus. The dual gasket viewing port allows the user to see into a chamber while in use. The viewing port has a cylinder that opens into the chamber. On the outer portion of the cylinder is a shoulder against which a plexiglass or other suitable material window is urged. The viewing window is held in place using a multiplicity of connectors. Positioned between the viewing window and the shoulder are two (2) gaskets—an inner gasket between the inside edge of the shoulder and the perimeter of connectors, and an outer gasket between the outside edge of the shoulder and the perimeter of connectors.

### BRIEF DESCRIPTION OF THE DRAWINGS

FIG. 1 is a front, perspective view of the hydrocarbon filtering apparatus.

FIG. 2 is a first side, perspective view of the hydrocarbon filtering apparatus.

FIG. 3 is a second side, perspective view of the hydrocarbon filtering apparatus.

FIG. 4 is a rear, perspective view of the hydrocarbon filtering apparatus.

FIG. 5 is a side, perspective view of the diffuser element.

FIG. 6 is a side, cutaway view of the diffuser element.

FIG. 7 is a cross-sectional view of the diffuser element.

FIG. 8 is a diagram illustrating the oil circuit.

### DETAILED DESCRIPTION OF THE PREFERRED EMBODIMENT

10 Hydrocarbon filtering apparatus
12 Inlet
14 Inlet valve
16 Vacuum pump
18 Knockout pot
20 Heater
22 Tower
24 Tower viewing port
26 Float valve
28 Float
30 Float arm
32 Tower viewing port shoulder
34 Tower viewing port connector
36a Tower viewing port outer gasket
36b Tower viewing port inner gasket
38 Tower viewing port cover
40 Extraction chamber
42 Diffuser element
44 Oil pump
46a First particulate filter
46b Second particulate filter
48 Outlet
50 Air intake
52 Air cooler
54 Knockout pot viewing port
56 Knockout pot viewing port connector
58 Knockout pot viewing port outer gasket
60 Knockout pot viewing port inner gasket
62 Knockout pot viewing port shoulder
64 Knockout pot viewing port cover
66 Vacuum pump vapor outlet
68 Vapor outlet inner pipe
70 Vapor outlet outer pipe
70a Vapor outlet outer pipe closed end
72 Control panel
74 Display
76 Roller
78 Base
80 Outer frame
82 Inner frame
84 Gauge
90 Diffuser core tube
92 End closure
94a Attachment end
94b Closed end
96 Mesh
98 Closure piece
100 Tube hole
102 Tube shaft
104 Large mesh
106 Tube opening
108 Tube interior
110 Spacer disc

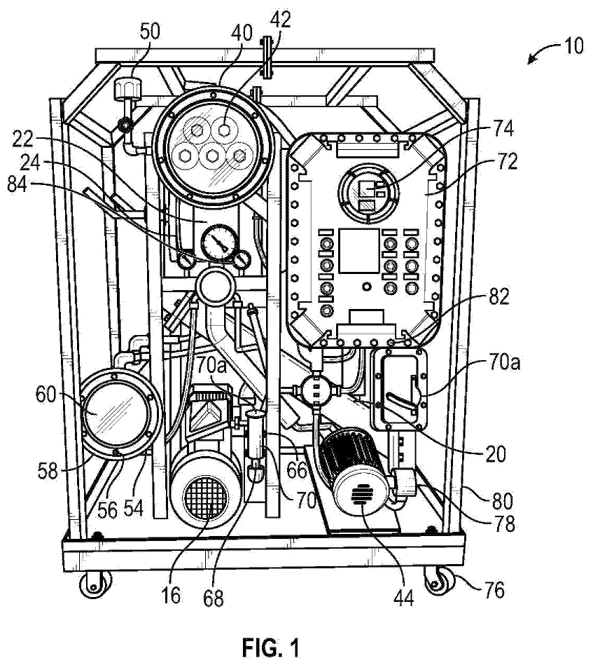

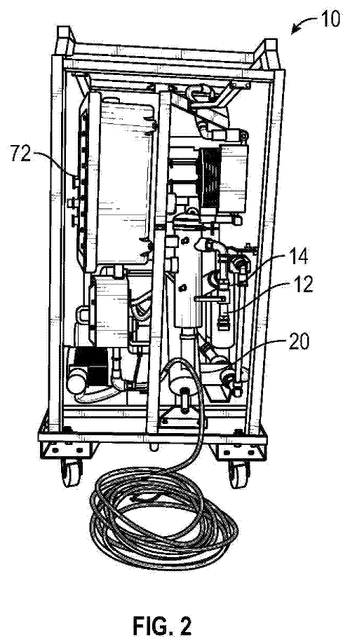

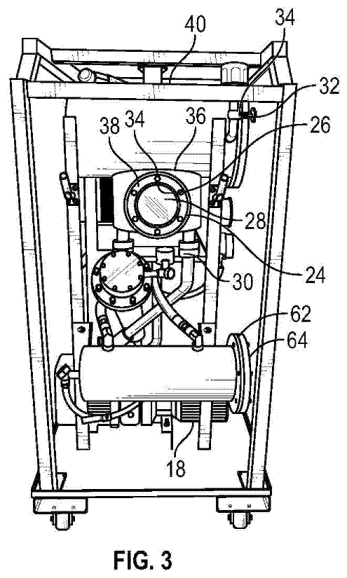

Referring to the figures, FIGS. 1-4 illustrate one embodiment of the hydrocarbon filtering apparatus 10. The hydrocarbon filtering apparatus 10 can be manufactured in a generally self-contained unit. The components of the hydrocarbon filtering apparatus 10 can be installed on a base 78. In order to increase the mobility of the hydrocarbon filtering apparatus 10 the base can have rollers 76. In order to help protect and support the hydrocarbon filtering apparatus 10 unit, there may be an outer frame 80 attached to the base 78 and extending around the hydrocarbon filtering apparatus 10 in three (3) dimensions. An inner frame 82 may be connected to the base 78 or outer frame 80. The inner frame 82 provides a skeletal-like structure to which the components of the hydrocarbon filtering apparatus 10 can be attached. Gauges 84 can provide information to the user such as pressure, temperature, and humidity readings.

The hydrocarbon filtering apparatus 10 itself is a series of components that are operably connected to each other. The hydrocarbon filtering apparatus 10 is a closed system, or oil circuit, in which hydrocarbon travels from the source then from element to element within the hydrocarbon filtering apparatus 10 and finally back to the source. It is presumed that all of the elements of the hydrocarbon filtering apparatus 10 are in mechanical communication with each other such that hydrocarbon can flow, or be pumped, throughout the filtering apparatus 10. Hydrocarbon is pumped from the source or reservoir (not shown) and enters the hydrocarbon filtering apparatus 10 at the inlet 12. The inlet 12 is in mechanical communication with the source (not shown) via an inlet hose (not shown). When a hose is mentioned herein, it is assumed that the liquid conveyance device could be a hose, pipe or other apparatus commonly used to transport liquids. The hydrocarbon travels into the inlet 12 entering the hydrocarbon filtering apparatus 10.

After entering the inlet 10, the hydrocarbon travels through the system to an inlet valve 14. When the inlet valve 14 is closed, it stops hydrocarbon from being gravity fed into the hydrocarbon filtering apparatus 10. For example, if the source (not shown) is above the hydrocarbon filtering apparatus 10 such that gravity would naturally cause the hydrocarbon to flow from the source into the hydrocarbon filtering apparatus 10, then the inlet valve 14—when it is in a closed position—stops the flow of the hydrocarbon. Inadvertent flow of the hydrocarbon into the hydrocarbon filtering apparatus 10 could cause the hydrocarbon to fill into unintended portions of the hydrocarbon filtering apparatus 10 such as entering into the vacuum system and leaking out the vacuum pump 16. In such a situation, the hydrocarbon could unintentionally fill up the knockout pot 18 and spill over into the vacuum pump 16. This would cause the hydrocarbon to spill and could drain the source which would be undesirable and a potential problem. Therefore, it is desirable to have an inlet valve 14 that closes in order to stop such from happening.

The inlet valve 14 stays closed until the hydrocarbon filtering apparatus 10 reaches an internal vacuum which acts to pull the stop valve (not shown) of the inlet valve 14 to an open position.

After passing through the inlet valve 14, the oil enters into a heater 20. In order to boil water, the water temperature must be raised to 212° F. or 100° C. at 1 atm of pressure (see level). However, the boiling point of water depends on pressure (impurities in the water can also cause the water to boil at a different temperature) and water boils at a lower temperature as pressure decreases. Thus, as the vacuum within the hydrocarbon filtering apparatus 10 increases, the pressure decreases and water in the system will boil at a relatively lower temperature. For example, if the pressure in the system is lowered by about 25 inches of mercury then water in the system will boil at approximately 120° F.

After passing through the heater 20, the hydrocarbon continues up a tower 22. The tower 22 is generally anticipated to be a vertically oriented chamber that is likely to be cylindrical or ovoid. Inside the tower 22 is a float valve 26 that helps maintain the level of hydrocarbon in the tower 22. As the level of hydrocarbon and the tower 22 raises, a float 28 also raises. The float 28 is connected to the float valve 26 via a float arm 30 and movement of the float 28 consequently causes movement of the float valve 26. Raising the float 28 causes the float valve 26 to close the aperture that allows entry of the hydrocarbon into the tower 22. Conversely, as the level of hydrocarbon lowers in the tower 22, the float 28 also lowers causing the float valve 26 to open and allow more hydrocarbon into the tower 22. The level of hydrocarbon in the tower 22 can be monitored by a user through a tower viewing port 24. The tower viewing port 24 is comprised of an aperture into the tower 22 with a tower viewing port shoulder 32 extending from the aperture and generally perpendicularly from the tower 22. A tower viewing port cover 38 is attached to the shoulder 32 and closes the aperture from the environment. The tower viewing port cover 38 is made from a clear material with characteristics and sufficient strength to withstand the hydrocarbons, temperature, and pressures associated with the system. A clear tower viewing port cover 38 allows a user to see into the tower 22 and monitor hydrocarbon levels. The tower viewing port cover 38 is attached to the shoulder 32 via a multiplicity of power viewing port connectors 34 located interspersed around the shoulder 32 and generally a ring. It is generally anticipated that the connectors 34 will be a type of bolt or related device. In order to help resist leaking of the hydrocarbon from between the shoulder 32 and the cover 38 a tower viewing port gasket 36 is aligned around the edge of the shoulder 32 and between the shoulder 32 and the cover 38. In the illustrated embodiment, there are dual gaskets in between the shoulder 32 and the cover 38—an outer gasket 36a between the outside edge of the shoulder 32 and the ring of connectors 34, and an inner gasket 36b between the inner edge of the shoulder 32 and the ring of connectors 34.

Hydrocarbon travels from the tower 22 into the extraction chamber 40. However, in order to enter the extraction chamber 40, the hydrocarbon is pushed through at least one diffuser element 42. Often, there is a multiplicity of diffuser element 42 in the extraction chamber 40. As illustrated in this embodiment (FIG. 1), there are five (5) diffuser elements 42. Hydrocarbon is pushed through the diffuser element 42 where contaminants in the hydrocarbon, particularly water, are separated from the hydrocarbon.

Hydrocarbon drops from the diffuser elements 42 into the extraction chamber 40. The separated hydrocarbon then moves out of the extraction chamber. The oil pump 44 may then push the hydrocarbon through a particulate filter. In the illustrated embodiment there is a first particulate filter 46a and a second particulate filter 46b. While the diffuser elements 42 act to separate off liquid contaminants, such as water, from the hydrocarbon, the particulate filters 46a and 46b filter solid contaminants from the hydrocarbon. The separated and filtered hydrocarbon is then moved on through an outlet 48 and through an outlet hose (not shown) back to the source (not shown).

The vacuum circuit is another component of the hydrocarbon filtering apparatus 10. Air is allowed to enter the system through the air intake 50. However, the air intake 50 is restricting such that there is not a free flow of air into the system. It is anticipated that air intake will be limited such that pressure in the system will equalized at approximately a range of 15 inches of mercury to 35 inches of mercury Like the oil circuit, the vacuum circuit is a system in which air is either evacuated from or travels from element to element. Also as above, it is presumed that all of the elements of the hydrocarbon filtering apparatus 10 are in mechanical communication with each other such that air can flow, the evacuated, or be pumped, throughout the components of the filtering apparatus 10.

Air that enters through the air intake 50 travels into the extraction chamber 40. From the extraction chamber 40 air travels into an air cooler 52. Mechanical communication from the extraction chamber 42 the air cooler 52 is through the top of the extraction chamber 42 so that it is less likely that hydrocarbons, which due to gravity will drop to the bottom of the extraction chamber 42, will enter into the air cooler 52. It is helpful to cool the air in the air cooler 52 because temperatures are elevated in the extraction chamber 42. Water vapor that has been extracted from the hydrocarbon travels with the heated air into the air cooler 52 where it condenses and then flows from the air cooler 52 into the knockout pot 18. It is desirable that the water flows into the knockout pot 18 so that it does not get into the vacuum pump 16. Like the tower 22, the knockout pot 18 has a knockout pot viewing port 54. The knockout pot viewing port 54 is comprised of a shoulder 62 and a cover 64. The cover 64 is attached to the shoulder 62 by a multiplicity of connectors 56 located around the circumference of the shoulder 62 and cover 64. The knockout pot viewing port 54 may have a single, or double, gasket between the shoulder 62 and cover 64. If it is a double gasket arrangement, it is anticipated that the inner gasket 60 will be between the ring of connectors 56 and the inner edge of the shoulder 62 or aperture and interior of the knockout pot 18, while the outer gasket 58 is positioned between the ring of connectors 56 and the outer edge of the shoulder 62. Unlike the tower 22, the knockout pot 18 will generally be a horizontally positioned cylindrical, or ovoid, chamber. Inside the knockout pot 18 is a float valve (not shown) that will shut off the system if liquid levels in the knockout pot 18 get too high and threatened to spill over into the vacuum pump 16. However, in practice, the vast majority of water in the system stays in a gaseous state as a water vapor and enters into the vacuum pump 16, and is expelled into the atmosphere from a vacuum pump vapor outlet 66. The vacuum pump vapor outlet 66 has an inner pipe 68 that comes from the vacuum pump 16 and points upwardly. An outer pipe 70 with a closed top end 70a fits down over the inner pipe 68 with space between the end of the inner pipe 68 and the end of the outer pipe closed and 70a, and space between the portion of the inner pipe 68 covered by the outer pipe 70 and the length outer pipe 70, so that air and gas can escape out the bottom of the outer pipe 70 but environmental liquids (such as rain) do not enter into the inner pipe 68.

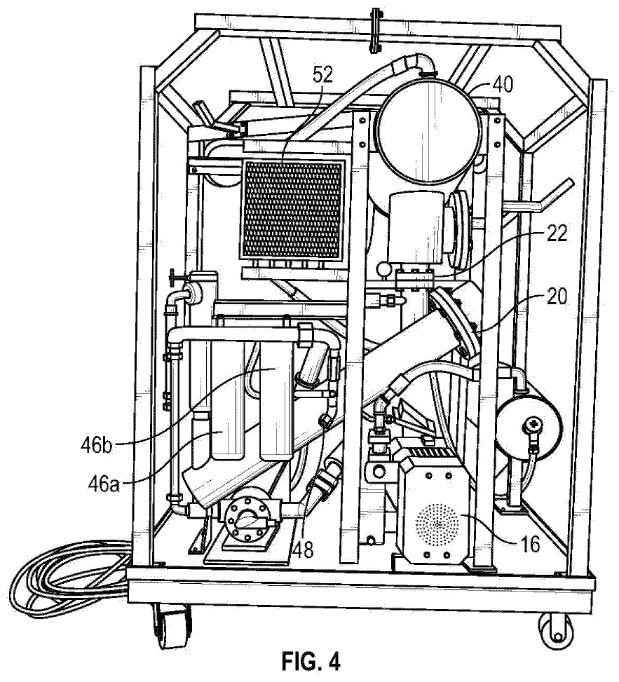

After water is removed from the hydrocarbons in the extraction chamber 40, the hydrocarbons are pumped through one or more particulate filters 46. In the embodiment shown in FIG. 4, there is a first particulate filter 46a and a second particulate filter 46b. After passing through the particulate filters 46, the oil is pushed out through the outlet 48 and back to the source (not shown)

The power for the hydrocarbon filtering apparatus 10 is anticipated to be electrical. A control panel 72 provides various control input devices such as, but not limited to, knobs, switches, and dials, so that a user can operate the hydrocarbon filtering apparatus 10. The control panel 72 can also provide output information to inform the user about operational characteristics of the hydrocarbon filtering apparatus 10. A display 74 can display information about the hydrocarbon filtering apparatus 10 to the user, such as, but not limited to, temperatures and pressures within the system, and system on/off. Typical controls that are anticipated to be available on the control panel 72 include, but are not limited to, system on/off, variable power or speed, a heater control, and a vacuum control. It is also anticipated that these various controls could be located elsewhere on the hydrocarbon filtering apparatus 10, and that no central control panel 72 be present.

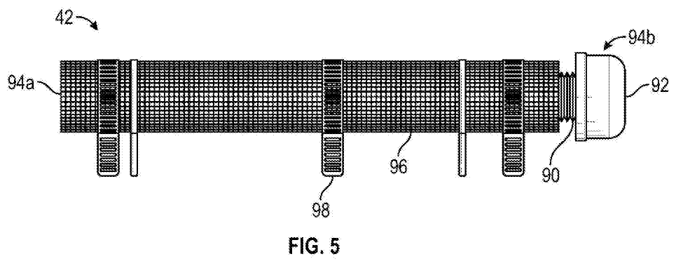

FIG. 5 is a side, perspective view of the diffuser element 42. The diffuser element 42 is made using a diffuser core tube 90 that has a multiplicity of tube holes 100 interspersed along the shaft 102 of the diffuser core tube 90. The diffuser core tube 90 has an attachment end 94a and a closed end 94b opposite from the attachment end 94a. The tube 90 is wrapped with a sheet of mesh 96 and the mesh 96 is held in place using a closure piece 98. The attachment end 94a may be threaded, have a quick release mechanism, or otherwise have a connection mechanism for putting the interior of the diffuser core tube 90 in operational communication with the remainder of the oil circuit of the hydrocarbon filtering apparatus 10.

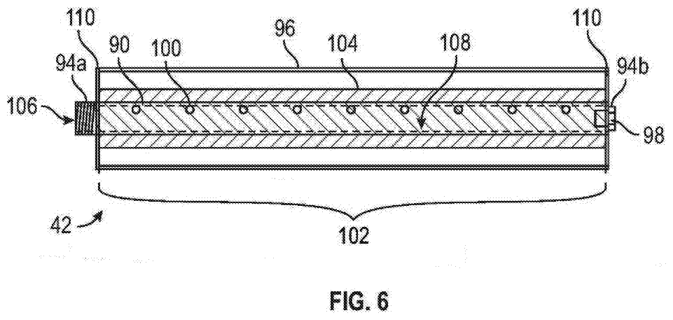

FIG. 6 is a side, cut-away view of the diffuser element 42. This figure illustrates the diffuser element 42 and shows the diffuser core tube 90 at the center of the diffuser element 42. The diffuser core tube 90 is a hollow tube with an interior 108 and a shaft 102. At one end of the diffuser core tube 90 is the attachment end 94a. The attachment end 94a has a tube opening 106 through which hydrocarbons can pass while traveling through the oil circuit of the hydrocarbon filtering apparatus 10. Additionally, the attachment end 94a maybe threaded or otherwise the connectable with the circuit of the hydrocarbon filtering apparatus 10 such that when the diffuser element 42 is attached it is in operative communication with the hydrocarbon filtering apparatus 10. The end of the diffuser element 42 opposite the attachment end 94a is the closed end 94b. The closed end 94b as a closure piece 98 attached such that the aperture of the diffuser core tube 90 is plugged and hydrocarbon inside the tube interior 108 cannot exit through the closed end 94b of the diffuser core tube 90. Rather, there are a multiplicity of tube holes 100 interspersed along the shaft 102 of the tube 90. Hydrocarbons that flow into the diffuser core tube 90 through the tube opening 106 of the attachment end 94a and into the tube interior 108 exit through the tube holes 100.

Wrapped around the diffuser core tube 90 is a sheet of mesh 96. The mesh 96 is anticipated to be of size 10 mesh to 100 mesh, where the size is based upon the number of cross threads per inch. Attached near each and of the diffuser core tube 90 is a spacer disc 110. The spacer disc 110 helps keep the wraps of the mesh 96 stacked horizontally from the diffuser core tube 90. Additionally, because the wraps of mesh 96 are urged between the spacer disc 110, hydrocarbons that exit through the tube holes 100 don't simply flow out the end of the mesh 96 stack and are forced to travel through the system of holes in the mesh 96 stack.

Because the mesh 96 has relatively small holes, there is a potential that the wraps of mesh 96 may plug its own holes. In order to help alleviate this potential problem, one or more large mesh sheets 104 may be inserted into the mesh 96 wraps. The large mesh 104 has larger holes which open up the passages of travel for hydrocarbons in the mesh 96 stack. It is anticipated that the large mesh 104 pieces will be relatively short as compared to the mesh 96.

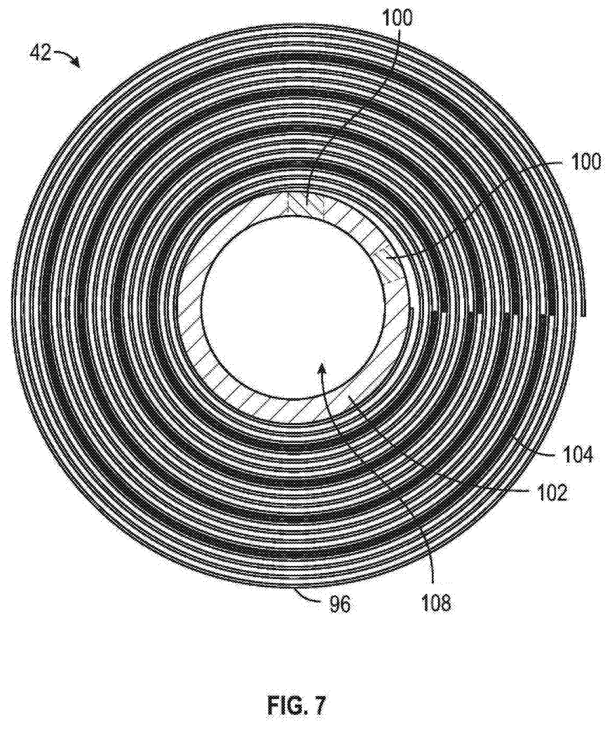

FIG. 7 is a cross-sectional view of the diffuser element. It illustrates the mesh 96 wrapped around the diffuser core tube 90. As shown in this cross-sectional view, the mesh 96 wraps around a portion of the tube shaft 102. Tube holes 100 are indicated in the tube shaft 102. The tube interior 108 can be seen in the center portion of the diffuser element 42. Within the wraps of the mesh 96 can be seen large mesh 104 wraps. In this embodiment, the large mesh 104 wraps are shown to be inserted in the complex every four (4) wraps of the mesh 96. Hydrocarbons would flow through the tube interior 108 and exit from the tube 90 through the tube holes 100, and then pass through the mesh 96 complex. Thus, the oil flow is from inside to out.

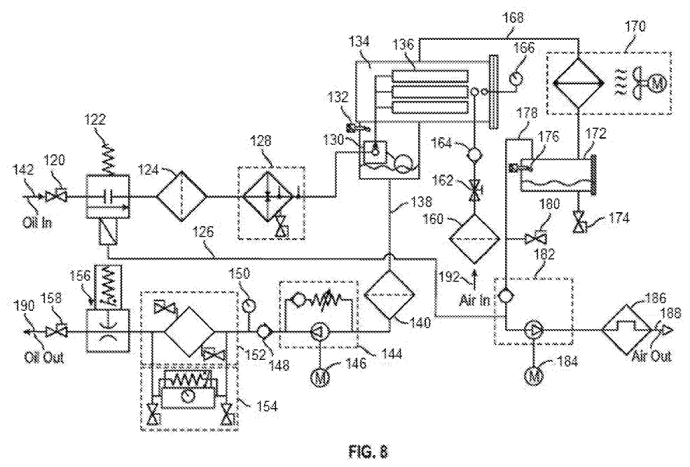

FIG. 8 is a diagram illustrating the oil circuit. This first embodiment illustrated and described in this figure while providing potential parts, is not intended to be limiting in regard to those parts and it is to be understood that many other parts with other specifications could be used to form different embodiments of the present invention. This first embodiment is for a 8 GPM (gallons per minute) oil purifier parts and instrumentation. It illustrates the flow of hydrocarbon through the filtration system.

The hydrocarbon is pumped from a source through an inlet hose 142 to a 304 stainless ball valve 120 with a 1″ national pipe taper (“NPT”) (NPT is a common U.S. standard for pipe fittings. NPT fittings are measured on the internal diameter of the fitting.) The hydrocarbon continues through a 1″ normally closed (“NC”) piston valve 122 and then through an inlet #4 bag filter 124 with 40 mesh (420 microns). The various parts are attached to and held in place by ¼″ stainless steel tubing 126. The hydrocarbon is warmed with a 12 kW immersion heater 128 with a low watt density type K thermocouple on elements & process. The hydrocarbon continues into a tower 22 that has a ¾″ level control valve 130 and a ½″ NPT horizontal float switch 132. The hydrocarbon is then pushed through five (5) 21″ dispersion elements 136 inside a 12″ 304 stainless vacuum extraction chamber 134. The filtered hydrocarbon is transported through 1½″ pump feed pipe 138 made from schedule 10 304 stainless steel into a 1½″ oil pump Y-strainer 140 made from 20 mesh (840 micron). A Gorman Rupp or Viking 8 GPM gear pump 144 with a relief valve set at 80 PSI, 15 GPM at 1800 RPM with a 1.5 HP explosion proof oil pump motor 146 act to transport the hydrocarbon on through a 1″ NPT stainless check valve 148. The hydrocarbon pressure inside the system is monitored by a 0 to 100 PSI glycerin filled pressure gauge 150 as the hydrocarbon is moved into a dual spin-on discharge filter housing 152. The hydrocarbon exits the system through a 1″ NPT 304 stainless ball valve 158 while monitored by a 0-50 explosion proof differential pressure indicator 154 with a set point set at 35 PSID and filter alarm with upstream and downstream ¼″ sample port valves, as well as a 1″ NPT low flow indicator 156 with alarm contacts set between 1 to 2 GPM. The oil out is an outlet hose 190 in operative communication with the ball valve 158.

Air in 192 is through inlet air spin-on filter element 160. The air passes through a ½″ NPT gate valve 162 for tower vacuum control and a ½″ NPT check valve 164. A −30″ HG to 0 PSI vacuum tower gauge 166 monitors the vacuum in the vacuum extraction chamber 134. Evaporated liquids extracted from the hydrocarbon pass through a 1″ petroleum transfer hose 168 to an air cooled heat exchanger 170 with ¼ HP electric motor in an 8″ diameter and into a condensate sump 172 made of 304 stainless steel. The condensate can be drained from the sump 172 through ¾″ NPT ball valve 174. Draining of sump is controlled by a ½″ NPT horizontal float switch 176. Air exits the sump 172 through a 1″ petroleum transfer hose 178 with flow controlled by a ¼″ NPT ball valve 180 used for vacuum pump rotor cleaning. The air is pushed on by a 40 CFM claw vacuum pump 182 with a 3 HP explosion proof vacuum pump motor 184, through a vacuum pump discharge diffuser 186 and out the air out 188.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A diffuser element for facilitating the separation of a liquid emulsified in a hydrocarbon from said hydrocarbon comprising:
a closed system through which hydrocarbon is pumped from a source and back to said source;
an extraction chamber in said closed system;
said diffuser element disposed in said extraction chamber;
a vacuum pump in mechanical communication with an interior of said extraction chamber wherein a vacuum can be created in said interior of said extraction chamber;
wherein said diffuser element is further comprised of:
a core tube having an attachment end and a closed end opposite each other;
said core tube having a circular cross section and a length;
wherein said core tube is hollow;
said attachment end of said core tube having an opening;
a multiplicity of holes along a length of said core tube; and
a length of mesh wrapped about said core tube.

2. The apparatus of claim 1, wherein said holes are positioned in the same 90° arc of said circular cross section along said length of said core tube.

3. The apparatus of claim 2, wherein said same 90° arc faces upwardly.

4. The apparatus of claim 1, further comprising a large mesh sheet inserted between the mesh wraps wherein said large mesh has larger holes than said mesh.

5. The apparatus of claim 1, further comprising:
a plurality of large mesh sheets inserted between the mesh wraps;
wherein said large mesh sheets have larger holes than said mesh; and
wherein said large mesh sheets inserted between different wraps.

6. The apparatus of claim 5, wherein said large mesh sheet is inserted between a 4^{th}, 5^{th}, or 6^{th} mesh wrap.

7. The apparatus of claim 1, wherein said length of mesh is wrapped a multiplicity of times about said core tube.

8. The apparatus of claim 7, wherein said multiplicity of wraps is three (3) or more times about said core tube.

9. The apparatus of claim 1, further comprising:
a first spacer disc attached to said core tube near said attachment end;
a second spacer disc attached to said core tube near said closed end; and
wherein said wrap of mesh is positioned between said first spacer disc and said second spacer disc.

10. The apparatus of claim 1, further comprising a heater in mechanical communication with said extraction chamber wherein said heater heats said hydrocarbon before said hydrocarbon enters said extraction chamber.

11. The apparatus of claim 10, wherein said holes are positioned in the same 90° arc of said circular cross section along said length of said core tube.

12. The apparatus of claim 11, wherein said same 90° arc faces upwardly.

13. A diffuser element for facilitating the separation of a liquid emulsified in a hydrocarbon from said hydrocarbon comprising:
a closed system through which hydrocarbon is pumped from a source and back to said source;
an extraction chamber in said closed system;
said diffuser element disposed in said extraction chamber;
a heater in mechanical communication with said extraction chamber wherein said heater warms said hydrocarbon before said hydrocarbon enters said extraction chamber;
wherein said diffuser element is further comprised of:
a core tube having an attachment end and a closed end opposite each other;
said core tube having a circular cross section and a length;
wherein said core tube is hollow;
said attachment end of said core tube having an opening;
a multiplicity of holes along a length of said core tube; and
a length of mesh wrapped about said core tube.

14. The apparatus of claim 13, wherein said holes are positioned in the same 90° arc of said circular cross section along said length of said core tube.

15. The apparatus of claim 14, wherein said same 90° arc faces upwardly.

16. The apparatus of claim 13, further comprising a large mesh sheet inserted between the mesh wraps wherein said large mesh has larger holes than said mesh.

17. The apparatus of claim 13, further comprising:
a plurality of large mesh sheets inserted between the mesh wraps;
wherein said large mesh sheets have larger holes than said mesh; and
wherein said large mesh sheets inserted between different wraps.

18. The apparatus of claim 17, wherein said large mesh sheet is inserted between a 4^{th}, 5^{th}, or 6^{th} mesh wrap.

19. The apparatus of claim 13, wherein said length of mesh is wrapped a multiplicity of times about said core tube.

20. The apparatus of claim 19, wherein said multiplicity of wraps is three (3) or more times about said core tube.
